(19) United States
(12) Patent Application Publication
(10) Pub. No.: US 2010/0240514 A1
(43) Pub. Date: Sep. 23, 2010

(54) Granulate, Process for the Production and Use Thereof

(76) Inventors: Ewald Mittermeier, Altfraunhofen (DE); Dieter Goedeke, Landshut (DE); Peter Elfner, Ergolding (DE); Sabine Pichler-Wilhelm, Landshut (DE)

Correspondence Address: PITTS AND BRITTIAN P C, P O BOX 51295, KNOXVILLE, TN, 37950-1295, US

(21) Appl. No.: 12/691,733

(22) Filed: Jan. 21, 2010

(30) Foreign Application Priority Data
Jan. 21, 2009 (DE) DE102009005446.4

(51) Int. Cl. C03C 14/00

(52) U.S. Cl. 501/32

(57) ABSTRACT

The invention relates to granulates, a process for the production thereof, in particular a process for the continuous production of these granulates, and use of the granulates for the manufacture of green compacts or compacts and further processing thereof into corresponding products, whereby the granulates have spherical particles with a smooth or smoothed, in particular fire-polished, surface.

### CROSS-REFERENCE TO RELATED APPLICATIONS

This application claims the benefit of German Application No. DE 10 2009 005 446.4, filed Jan. 21, 2009, which is hereby incorporated by reference.

The invention relates to granulates, a process for the production, in particular for the continuous production of these granulates, and use of the granulates for the manufacture of green compacts or compacts and further processing thereof into corresponding products.

Granulates are grainy, easily pourable solids that are composed of a powdery base material, such as glass, ceramic, carbides or other materials, and contain a binder made from one or a plurality of binding agents. The binder usually contains polymeric materials that are soluble or at least swellable in a dispersion or carrier medium to be used.

The range of applications for granulates is very diverse; it is used preferentially for dry molding. These granulates are used, for example, for the production of high-quality composite materials or material compounds such as insulation and construction materials in electrical engineering, for example as electrode material or resistor material, in the automotive industry, the chemical industry, in coatings, renders, filling materials, adhesives and coverings in the construction industry, particularly in ceramic compounds. The mineral raw materials are initially milled into powders then converted into granulates for the production of ceramic compounds for example. These are used, for example, as dry molding compounds, e.g. tiles, etc. Granulates in general are made into the appropriate shape, for example, by compression, plastic deformation, such as extrusion or injection molding or casting. Following appropriate molding, the material is fabricated into a green body or green compact which, after a mechanical processing step if necessary, is sintered (fired) resulting in a compact that may be further processed depending on the field of use.

The production of granulates is carried out, as is known, by producing a suspension of the base material(s), the binder and a carrier medium, in particular water, with a defined solid content and by adding appropriate additives, and subsequently spraying the suspension through a nozzle. It is possible to modify or adjust various granulate properties, such as particle size distribution, bulk density, flowability and similar, via the parameters of the spray drying process, such as spray pressure, nozzle geometry, drying temperature and drying speed.

There are numerous suggestions in the prior art for improving the material properties of composite systems that contain particles:

WO 2006/018347 A1 for example describes a ceramic electrical resistor that can be produced by the pyrolysis of an organosilicon polymer based on a polysiloxane or a polysilesquioxane, containing at least one filler, whereby the ceramic resistor has an aluminum silicate as the filler to improve its long-term durability. In this case, a portion of the filler particles may be used as spherical particles.

Moreover, WO 98/27575 describes a sintered electrode of high-melting metal, such as tungsten, that is composed of spherical metal powder whereby the average particle size is between 5 and 70 μm and the particle size distribution fluctuates around the average particle size by no more than 20%.

WO 03/072646 A1 describes a cast resin system in which the proportion of filler is increased to values 50 vol. % by comparison with conventional cast resin systems without restricting the workability of the casting resin due to an increase in viscosity. To do this, fillers that are present as a combination of at least two filler fractions with a different particle size distribution are added to the casting resin. These are generally inorganic fillers that are essentially fine to coarse grained, spherical, splintery, flaky or short-fibred.

In addition, WO 03/072525 A1 relates to ceramic compounds for the production of ceramic materials and products with low shrinkage by means of extrusion, casting and/or injection molding whereby the solid content accounts for at least 60 vol. % and there are at least two fractions of different particle size distribution. The two fractions differ in respect of their average particle size by a factor of 4 to 5 and are obtained by means of different milling processes during which milling is carried out (down) to different particle sizes.

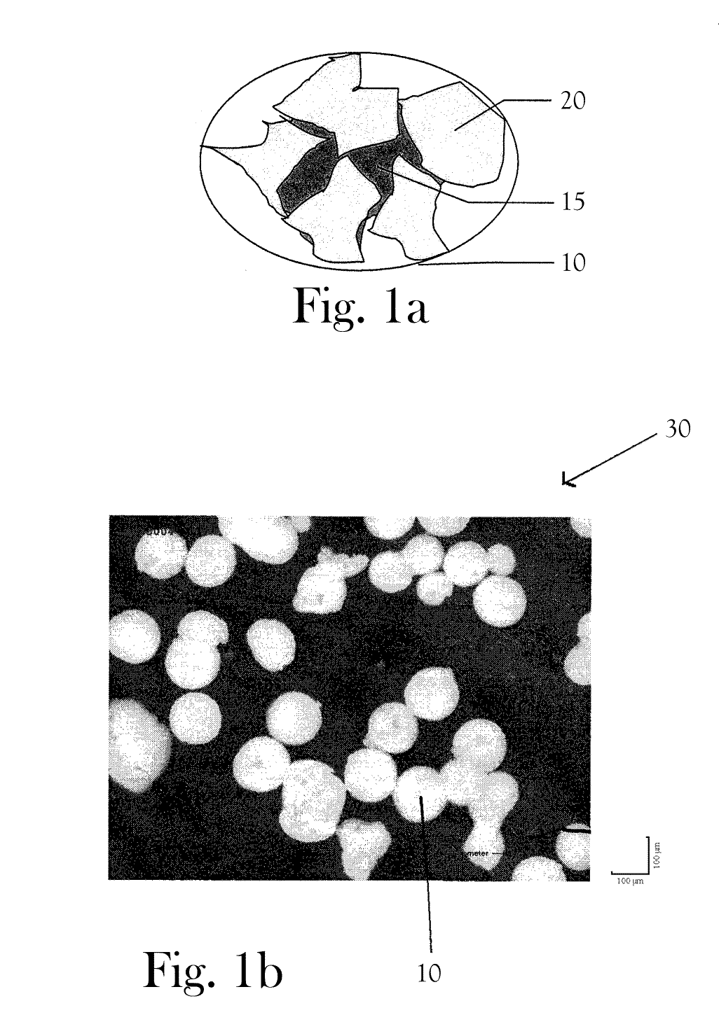

As already explained, the powders normally used in the prior art are generally milled. These powders produced in this way therefore contain particles that have a splintery surface and an irregular shape. Both the surface and also the shape of the particles lead to a bulky arrangement of these particles in the granulates, particularly in each individual granulate particle. Investigations by the inventor have shown that even when using such particles that have essentially the same size, this results in granulates whereby, for example, the volume of the free spaces between the individual spherical particles, i.e. the pore volume, accounts for over 40% of the total volume. This is illustrated in the form of a diagram in FIG. 1a. FIG. 1a shows a single granulate particle 10, subsequently also referred to as a “granule”, that is composed of particles 20 with an irregular shape and splintery surface according to the prior art whereby the result is an extraordinarily large pore volume 15. Such particles contained in the granulates according to the prior art are referred to subsequently simply as “standard particles”. The binder has been left out in FIG. 1a for reasons of clarity.

Irregularly shaped granules, such as doughnut-shaped granules that are hollow inside, are formed during granulate production using the standard particles according to the prior art that have a splintery surface and irregular shape. These doughnut-shaped hollow granules are illustrated for example in FIG. 1b based on a microscopic image. These doughnut-shaped hollow granules are caused on one hand by the irregularly shaped standard particles and on the other by the explosive escape of entrained carrier or dispersion medium during drying. In addition, the formation of a skin which ensures there is no unimpeded escape of the carrier or dispersion medium is frequently observed during the drying of standard particles and thus contributes to the destruction of the structures formed. This ultimately results in an irregular shape of the granules. The granules thus produced have a low density. This also affects the quality of products manufactured using these granulates, for example due to a reduced density of the green compact or compact. Moreover, a compact produced using these granules also has no homogeneous structure.

The object of the present invention is thus to overcome the disadvantages arising from the prior art described and to provide granulates which have improved properties so that it is possible to produce a product with improved properties from them. The intention is also to provide a process for the production of granulates which delivers the desired granulates in a simple and inexpensive manner. In addition, the intention is also to provide products that can be produced using the granulate, such as green compacts, compacts and similar.

The inventors have now ascertained that the geometry and surface condition of the powdery base material is decisive for the quality of the granulate and the products produced from it, such as green compacts, compact and similar.

Thus the object according to the invention is met by granulates having one or more binders as well as spherical particles with a smooth or smoothed, in particular fire-polished, surface. These particles with a spherical shape and preferably fire-polished surface are subsequently referred to simply as “particles” or “particles according to the invention”. If necessary, the granulate may also contain non-spherical particles, such as splintery polymorphous particles for example, that have not been subjected to any surface treatment while smoothing of the surface, particularly fire-polishing (“standard particles”). The proportion of spherical particles with a smooth or smoothed, in particular fire-polished, surface in the total volume of particles introduced is 0.5% to 100% according to the invention.

The particles according to the invention are spherical particles. “Spherical” particles within the scope of the invention mean such particles as are rounded or are already present as round and have a shape that is approximated as closely as possible to the exact and ideal spherical shape. The spherical shape should be round and not oval and have no points, scratches and sharp edges. There should also be a continuous surface of the spherical shape in the sense of there being as far as possible no deviation from the round shape. The entire surface of the particle should thus be approximated as closely as possible to the exact sphere.

A shape approximated as closely as possible to the ideal spherical shape is defined according to the invention by way of the roundness according to Retsch Technology GmbH by the following formula:

4×π×A/U

Where:

A . . . is the area of the particle image

U . . . is the circumference of the particle image.

Roundness describes the ratio between the area of a particle image and the circumference. According to this, an ideal spherically shaped particle would have a roundness close to one (100%), while a jagged, irregular particle image would have a roundness close to zero (0%). The measuring instrument used to measure the roundness according to the present invention is the CAMSIZER by Retsch Technology GmbH.

According to the invention, a roundness>70% may be assumed to be sufficient as suitable for the teaching according to the invention if one assumes a perfect sphere to have a roundness of 100%.

The production of such spherical particles is carried out by way of processes known in the prior art. The spherical shape of the individual particles may also be demonstrated by means of known technical measuring methods, such as optical methods, e.g. microscopy, measuring methods to determine the specific surface or similar methods.

The particle may either already be produced in the required spherical shape or the particles may be converted into the desired spherical shape (“rounded”) after production using an appropriate process. This may be achieved, for example, by flame-rounding, the sol gel route, pyrolysis or milling or in another manner.

Preferentially according to the invention, what is referred to as fire-polishing is carried out. The material melts on the surface due to the heat of a flame and cools down again as a smooth surface. This is used, for example, for glass or glass ceramics. Fire-polishing succeeds in controlled remelting of the glass surface, rough structures are dissolved and the result is a higher degree of smoothness. The surface is therefore smooth or smoothed.

The slickness or smoothness of the particles' surface is defined according to the invention based on the roughness of the surface. The roughness of the particle surfaces present according to the invention is preferably around an Ra value<10 nm, more preferably <5 nm, even more preferably <1 nm, quite especially preferably <0.8 nm, particularly preferably the Ra value is in the range of 0.3 nm to 0.5 nm.

The Ra value is measured using an AFM (atomic force microscope). The instrument used for the measurement in accordance with the present invention was an AFM “Dimension 3100” by Digital Imaging.

Fire-polished glass or glass ceramic particles with a rounding of preferably >70% are especially preferred according to the invention. Reference is made to DE 198 39 563 A1 in respect of fire-polishing, the disclosed content of which is included by reference in the present disclosure.

The parameters for fire-polishing must be determined in each individual case depending on the material selected, its size and shape and intended use. The person skilled in the art can readily determine the type, duration and extent of fire-polishing by a small number of orientation experiments based each time on his general knowledge and based on the present disclosure in addition to information from the literature.

Naturally, it is also possible to use commercially available products that already meet the described criteria for shape and surface condition. Full glass beads are one example of commercially available particles that meet these criteria.

The particle size of the spherical particles is not especially restricted within the scope of the invention. Average particle sizes d₅₀ ranging from 0.2 μm to 100 μm are particularly preferred. The granule preferably has a diameter ranging from 20 μm to 500 μm, more preferably from 40 μm to 200 μm, but in individual cases may also lie outside the preferred range. The number of particles in a granule may vary within wide ranges and ranges, for example, from 2 to 100 particles per granule whereby this depends, for example, on the size of the particles used and may also, therefore, be exceeded.

The particles may also represent a mixture of particles with different diameters. The particles used may have mixtures of particles with two, three or more different sphere diameters, each with the lowest possible distribution range of the individual particle size. Selection of the particle diameters depends on the granulate to be produced and the granulate's intended use, the area of use and the required properties of the products to be manufactured.

For example, the packing density of the individual granules and thus of the granulate may be further increased by specifically mixing large and/or small particles of powder such that the small particles can settle in the pores of the large particles, whereby both the large and also the small particles of powder are present with a correspondingly smooth, in particular fire-polished, surface. For example, the small spherical particles may have a d₅₀ particle size ranging from approximately 1 μm to approximately 10 μm while the large spherical particles have a d₅₀ particle size ranging from approximately 2.5 μm to approximately 30 μm. According to the invention, nanoparticles may also be used.

Due to the particles according to the invention, which are spherical in shape and have a smooth or smoothed, in particular fire-polished, surface, the result is preferably granules with an approximately spherical shape.

Thus it is possible with the spherical particles of powder according to the invention to produce granulates in the spray process whereby the individual granules of the granulate are preferably spherical in shape. These spherical granules preferably have the particles in a dense spherical packing arrangement. The pores, i.e. the spaces, between the spherical particles then leave a defined space free so that during the drying process of the granules the carrier medium can escape readily without destroying or altering the shape of the individual granulate particles or granules. Even in granulates manufactured from suspensions by means of spraying, the material components of which tend to form a skin during drying, escape of the carrier medium is guaranteed via the pores formed without destroying the dense spherical packing created. In addition, the granules of the granulate produced using the particles according to the invention are not hollow—unlike the granules manufactured by spray drying in the prior art. Therefore, according to the invention, this completely prevents the formation of bulky granules or even hollow or doughnut-shaped granules.

The granulate of the invention may also represent a mixture of spherical particles with a smooth or smoothed, particularly fire-polished, surface and non-spherical particles with a non-smooth or non-smoothed surface, i.e. standard particles. The spherical particles may be a grade of particles with a single diameter or a mixture of particles with two or more diameters. The standard particles too may be particles of equal size or may represent a mixture of particles with different sizes.

It is possible to improve the strength of the granulate manufactured as well as the packing density by mixing standard particles, i.e. particles produced with a splintery surface and irregular shape, with particles used according to the invention, which are rounded or are already present as round, in the appropriate particle size ratios and proportions. Moreover, it is also possible to improve the properties of products that are further processed, particularly in respect of strength and density.

Selective adjustment of spherical smooth, in particular fire-polished, particles to standard particles in varying ratios makes it possible to modify the granulate's properties.

In accordance with a preferred embodiment according to the invention, the mixture of spherical particles with a smooth or smoothed surface to standard particles is in the ratio of 2:1 to 9:1, preferably in the ratio of 4:1. Especially preferably 50% or more of all particles in the granulate are spherical or rounded and fire-polished particles according to the invention, particularly 50% to 100%, preferred contents lie between 80% and 90%. Quite especially advantageous are compositions of rounded or round particles to standard particles of an average particle size d₅₀ of approximately 10 μm: an average particle size d₅₀ of approximately 5 μm.

The diameter of the standard particles is determined in that an (ideal) sphere that specifically surrounds the irregularly shaped particles is constructed around the existing irregularly shaped particles and the diameter of these spheres is determined. This describes a normal procedure known to the person skilled in the art from the prior art.

During processing of the granulates, the spherical shape of the granules and their smooth, in particular fire-polished, surface has a further positive effect on the granulate's flow and filling behavior. This is illustrated by Table 1 below in which the granulate properties are reproduced as a function of the mixture composition of the particles.

TABLE 1

| | Composition: | | | | | |
|---|---|---|---|---|---|---|
| | Rounded (R) to standard | | | | | |
| | (S) particles | | | | | |
| | | 90% R: | 80% R: | 50% R: | 20% R: | 100% R |
| | 100% R | 10% S | 20% S | 50% S | 80% S | 0% S |
| Flowability in | 40.02 | 44.24 | 46.87 | 57.91 | 62.84 | 73.4 |
| [s] | | | | | | |
| Bulk density | 1.014 | 0.937 | 0.901 | 0.819 | 0.739 | 0.71 |
| in [g/ml] | | | | | | |
| Breaking | low | medium | high | high | high | high |
| strength | | | | | | |

Experiments have shown that the granulates according to the invention lead to an improvement in the filling ratio of at least 30% compared to standard granulates from the prior art.

Advantageously, at least 5 weight %, preferably at least approximately 20 weight %, particularly at least 25 weight % of spherical particles with a smooth or smoothed surface are present in the granulate. Particularly advantageous properties are achieved with a content of particles according to the invention ranging from approximately 5% to approximately 100%.

The material of the spherical particles is not further restricted according to the invention. Any material that can be converted into a granulate may be used. The use of glass or glass ceramics is especially preferred.

According to the invention, the binder is not especially restricted. Any appropriate binder or a mixture of two or more binders may be used. Homopolymers or copolymers, for example, may be used. The following are merely mentioned by way of example: (meth)acrylate, (meth)acrylamide, epoxy compounds, vinyl ether or mixtures thereof.

Naturally, the granulates may also be modified in the usual way by means of surface coatings and/or treatments. The spherical particles may then be coated at least in part on the surface. To do this, functional groups, for example, which correspondingly modify the properties, may be applied to the surface of the particles. By this means, for example, it is possible to increase the adhesion to the binder or to modify the setting behavior.

The special properties of the granulates according to the invention with their preferably spherical shape and smooth or smoothed surface also affect the products manufactured using these granulates. For example, the advantages of dense spherical packing become important. By using preferably spherical granulates produced from spherical particles, green compacts, for example, are created with cubically face-centered and/or hexagonally the densest spherical packing. The maximum packing density of spherical particles of theoretically equal size is 74% in these types of packing Filling the pores then results in packing densities of over 90%.

In particular, the mixture composition (see e.g. Table 1 above) also has an effect on the filling depth of a pressing tool. The filling depth in a pressing tool is the distance the die travels between the top and bottom dead centre. The lower the filling depth, the better the filling behavior and the denser the green compact. The filling space of the pressing tool fills up optimally when using the granulate according to the invention, i.e., dense spherical packings also form on the granulate level. As the granules themselves preferably have a spherical shape and a smooth, in particular fire-polished, surface, and as they are essentially composed of the particles according to the invention, the granules in the form of the granulate also preferably form a densest spherical packing. The density of the granulate according to the invention is, therefore, also high due to the high packing density of the granules. Small spaces in particular (<0.1 mm) can be filled significantly more effectively.

During the pressing procedure, the granules therefore flow into one another more easily under pressure such that it is possible to manufacture compacts with a high packing density and homogeneous compaction.

Another advantage during further processing of the granulates according to the invention, particularly in the form of compacts, is that the binder can be baked out easily due to the inherent structure of the spherical particles and as a result the volume of bubbles can be reduced.

Moreover, products that are further processed have an homogeneous microstructure as well as very low weight tolerances, i.e. high constancy in weight in the case of mass-produced products. Also of great benefit are the very low dimensional tolerances of the products manufactured from the granulates, which can be achieved with a high degree of accuracy.

Furthermore, when using the granulate according to the invention, it is also possible to actually manufacture difficult to produce compacts with small wall thicknesses and unfavorable height to width ratios which cannot be manufactured using the granulates from the prior art. Due to the granulate according to the invention it was also generally possible to increase the yield; a yield improved by approximately 20% was obtained in experiments.

The granulates according to the invention are also of particular benefit for further processing into compounds such as glass/metal, glass/glass, glass/glass ceramic, glass/ceramic or glass ceramic/metal compounds that may be manufactured from compacts. Further preferred areas of application are vitreous solders that may be produced from compacts manufactured from granulates according to the invention.

The subject of the invention is also a process for the production of granulates comprising the steps:

production of a slip, containing dispersion medium, spherical particles with a smooth or smoothed, in particular fire-polished, surface, if necessary standard particles (non-spherical particles with a non-smooth or non-smoothed surface), one or a plurality of binders and if necessary additives, selected from defoamers, stabilizers, pressing additives and similar; as well as

spraying of the slip to obtain a granulate, the individual granules of which are not hollow.

In the process according to the invention the granulates according to the invention are manufactured by means of a spray drying process whereby the granulates have one or a plurality of binders in addition to spherical particles with a smooth or smoothed and in particular fire-polished, surface and if necessary standard particles.

To manufacture the granulates, first of all a slip is produced which, in addition to the spherical particles of the invention, also contains an organic or inorganic carrier or dispersion medium. The slip preferably has water as the dispersion medium. Traditionally, further additives, such as defoamers, stabilizers, pressing additives and similar, are used in addition to the existing binder.

The subject of the invention is also a suspension-stabilized slip for the manufacture of a granulate, comprising dispersion medium, in particular water, one or a plurality of binders in addition to spherical particles with a smooth or smoothed, in particular fire-polished, surface and if necessary non-spherical and non-fire-polished particles in addition, if necessary, to additives.

The slip is subsequently processed into a granulate in the usual way using a spray drying process. The parameters of the spray drying process, such as spraying speed, spray pressure, nozzle geometry, drying temperature and drying speed, depend on the material used, quantity and size of the particles, the choice of binder(s) and carrier medium as well as the desired granulate properties, such as particle size distribution, bulk density, flowability and similar.

One advantage of the slip, which is manufactured using the granulate according to the invention, is that the slips of the invention produced from rounded or round or spherical particles lead to significantly lower wear of machine and structural parts and therefore simultaneously ensure less contamination of the particles. This is because the spherical particles with their smooth surface held in the slip exhibit considerably less abrasion on structural and machine components, such as nozzles in the spray process, than a slip that is composed only of particles with a splintery surface. In addition, it has been shown surprisingly that a higher suspension stability of the slip can be achieved by means of the spherical particles according to the invention with a correspondingly smooth or smoothed, in particular fire-polished, surface.

The process according to the invention may be carried out in batches or continuously, preferably the process is carried out continuously.

The invention also relates to a process for the manufacture of a compact from the granulate according to the invention, containing one or a plurality of binders as well as spherical particles with a smooth or smoothed, in particular fire-polished, surface, having the steps:

milling of the spherical particles to an average particle size d₅₀ ranging from 0.2 to 100 μm;

fire-polishing of the spherical particles to smooth the surface;

production of a granulate from the particles obtained, binder, if necessary with the addition of non-spherical particles with a non-smoothed surface and if necessary further additives;

pressing of the granulate to obtain a green compact; and

sintering of the green compact to obtain a compact.

The process according to the invention for the manufacture of a compact is based on the process described above to manufacture the granulate according to the invention which is subsequently followed by corresponding pressing and sintering, as known from the prior art. The individual process parameters depend on the materials selected and the intended use.

The subject of the invention is also a compact or green compact, manufactured using the granulate according to the invention and the products producible using the compact, such as a glass/metal compound or a vitreous solder.

The spherical particles according to the invention with smooth surfaces therefore lead to a number of significant benefits:

Thus the granulates provided according to the invention, having spherical particles with a smooth surface, are not hollow and have low residual moisture in addition to improved flow properties compared to conventional standard granulates. The properties of the granulates can be correspondingly modified and sometimes even considerably improved by using mixtures of spherical and non-spherical particles. For example, during processing of the granulates, the spherical shape of the granules and their smooth surface has a positive effect on the granulate's flow and filling behavior. The granulates according to the invention lead to an improvement of the filling ratio of at least 30% compared to standard granulates from the prior art. Furthermore, when using the granulate according to the invention, it is also possible to produce difficult compacts with small wall thicknesses and unfavorable height to width ratios that are not accessible via standard granulates. It is also possible to significantly increase the yield of the products produced.

Furthermore, by using the granulates according to the invention, a high density occurs which also leads to a high density of the resulting products when further processed. For example, a high green compact density or a high density in compacts can be obtained.

Accordingly, the use of the spherical particles according to the invention with a smooth or smoothed surface leads to a significant increase in quality of the granulates produced and of the products manufactured from the granulates.

The present invention is subsequently explained on the basis of Figures which are intended to illustrate but not restrict the teaching according to the invention. The Figures show:

FIG. 1a a granule from the prior art in a simplified schematic diagram;

FIG. 1b a microscopic image of a granulate from the prior art;

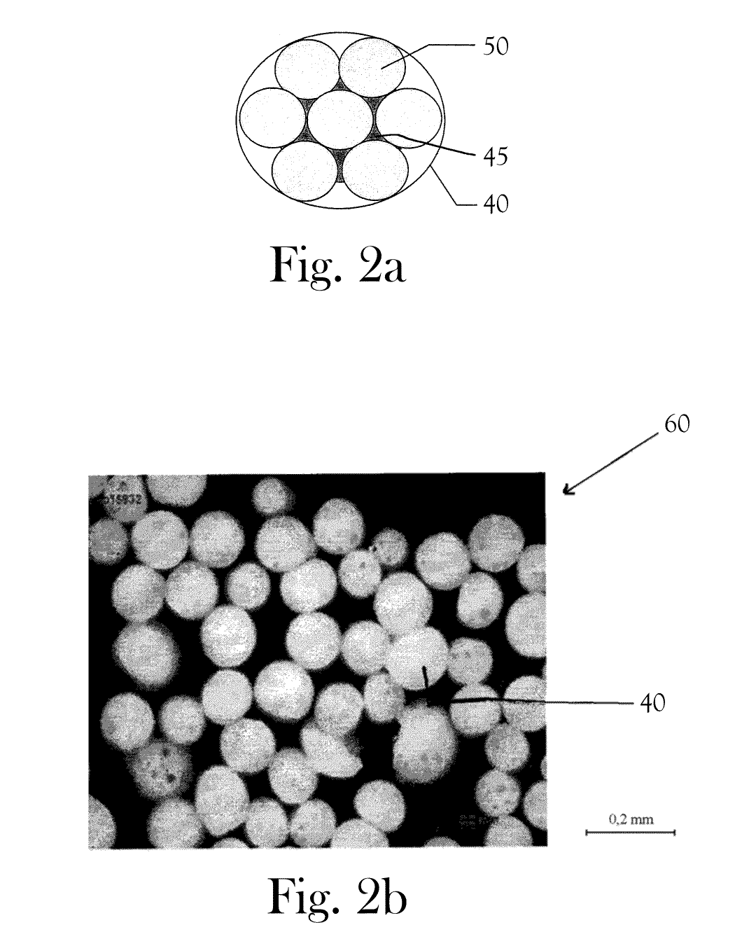

FIG. 2a an embodiment of a granule according to the invention in a simplified schematic diagram;

FIG. 2b a microscopic image of an embodiment of a granulate according to the invention;

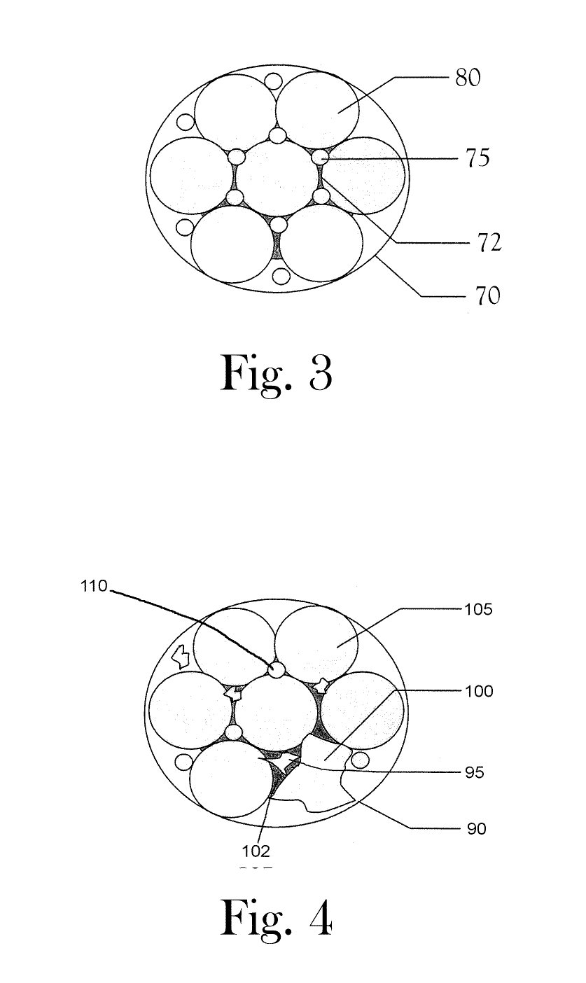

FIG. 3 another embodiment of a granule according to the invention in a simplified schematic diagram;

FIG. 4 a further embodiment of a granule according to the invention in a simplified schematic diagram;

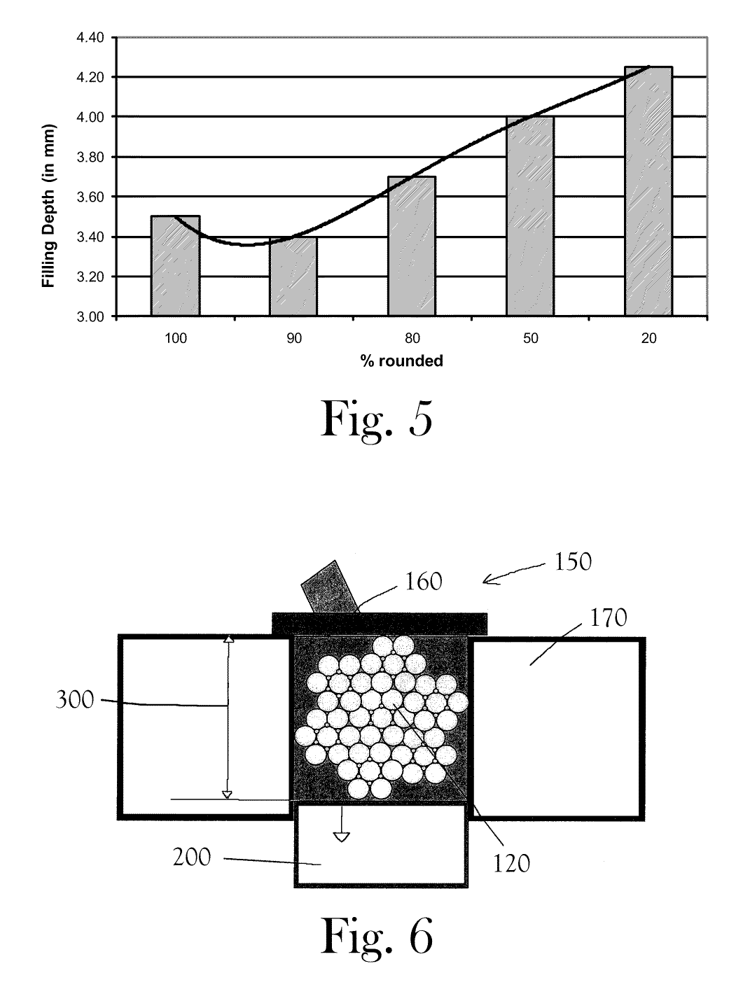

FIG. 5 a diagram that illustrates the effect of the particle composition (standard particle/rounded particle) on the filling depth FIG. 6 a granulate according to the invention, poured into a conventional pressing tool, in a simplified schematic diagram; and

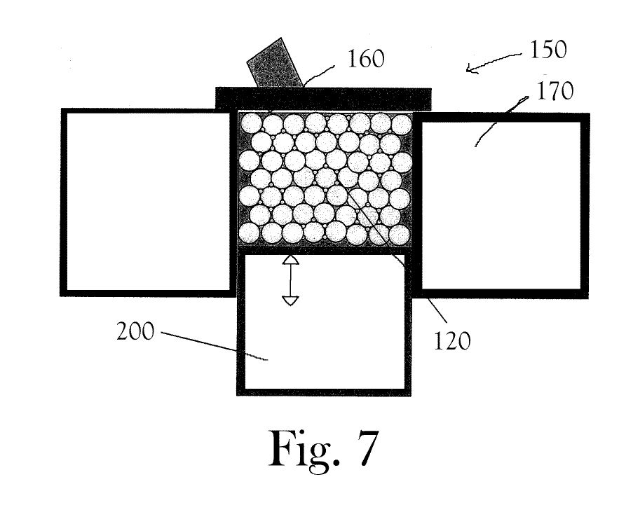

FIG. 7 the packing density of compacted granules according to the invention in a simplified schematic diagram.

FIG. 1a illustrates in a simplified schematic diagram a granule 10, composed of particles 20, such as are used in the prior art. Pores 15 occur within granule 10 formed by particles 20. The binder has been left out in FIG. 1a for reasons of clarity. These powder particles 20 are manufactured by milling, for example, and have a splintery surface and an irregular shape. Both the surface and also the shape of particles 20 lead to a bulky arrangement of particles 20 in granule 10. This results in the creation of extremely large spaces between powder particles 20.

FIG. 1b shows a light-microscopy image of a granulate 30 from the prior art. The image was taken using a reflected-light microscope. The granulate in question is a glass granulate.

Granulates 30 manufactured with standard particles 20 have preferably doughnut-shaped hollow granules 10, as emerges from FIG. 1b, because carrier medium entrained during drying escapes explosively and thus determines the shape. These granules 10 from the prior art have a low bulk density and lead to further processed products, for example green compacts or compacts, with reduced density and insufficiently homogeneous microstructure.

FIG. 2a shows in a simplified schematic diagram an embodiment of a granule 40 according to the invention that has spherical particles 50 with a smooth surface. Unlike in the prior art, granules 40 according to the invention are not hollow. Due to the spherical shape and smooth surface of particles 50, it is possible in granule 40 to produce the densest spherical packages with correspondingly reduced pore volume 45. Naturally, not every granule 40 always has the same number of particles 50. The number of particles 50 shown is only 7 by way of example.

FIG. 2b shows a light-microscopy image of a granulate 60 according to the invention whereby the result is full granules 40 with a spherical shape and correspondingly smooth or smoothed surface. In the main phase, the granulate is comprised of glass.

FIG. 3 illustrates in a simplified schematic diagram another embodiment according to the invention whereby granule 70 according to the invention is composed of a mixture of particles 75, 80 according to the invention having two different diameters. Granule 70 according to the invention has large spherical or rounded particles 80 and small spherical or rounded particles 75. Granule 70 also has a spherical shape and a smoother surface per se due to existing spherical particles 75, 80. In the example case illustrated, small spherical or rounded particles 75 can correspondingly fill out pore volumes 72 formed by large spherical or rounded particles 80. Naturally, it is also possible to have size ratios of particles 75, 80 other than those shown.

FIG. 4 illustrates in a simplified schematic diagram a further embodiment according to the invention of a granule 90 according to the invention which is composed of a mixture of particles 105, 110 according to the invention and standard particles 95, 100. Both particles 105, 110 and also standard particles 95, 100 each represent mixtures with two different sizes or diameters. As a result, large particles 105 and small particles 110 as well as small standard particles 95 and large standard particles 100 are present next to one another in granule 90. As a result of this, small particles 110 and small standard particles 95 can fill out pores 102 formed. Standard particles 95, 100 lead, due to their splintery and irregular shape, to interlocking which increases the break strength of granule 90 according to the invention. This also gives rise to further processed products with increased breaking strength.

FIG. 5 illustrates in a chart the effect of the particle composition on the filling depth. The filling depth in mm is plotted against the % value of the spherical or rounded particles. The lower the filling depth, the better the filling behavior and the denser the granulate. The best filling depth in the example case illustrated is thus obtained with a proportion between 90% and 95% of the spherical particles.

FIG. 6 shows in a simplified schematic diagram the dense arrangement of a granulate 120 according to the invention, containing spherical particles, after the filling operation of a schematically represented pressing tool 150. Filling takes place via filling shoe 160 into a mould 170 above a die 200 with a defined filling depth 300. The cavities of the pressing tool fill up optimally in this case by using granulate 120 according to the invention, i.e. dense spherical packings form on the granulate level. The density of granulate 120 is exceptionally high due to the high packing density of the granules. So during the pressing procedure, the granules flow into one another more easily under pressure such that it is possible to manufacture compacts with a high packing density and homogeneous compaction.

FIG. 7 shows in a simplified schematic diagram the dense spherical packing of compacted granulate 120 according to the invention in addition to a homogeneous distribution of compaction in pressing tool 150.

1. A granulate comprising at least one binder in addition to a quantity of particles including substantially smooth spherical particles, the proportion of substantially smooth spherical particles amounting to 0.5% to 100% of the total quantity of particles introduced into the particulate.

2. The granulate according to claim 1 characterized in that the individual granules of the granulate are substantially spherical in shape.

3. The granulate according to claim 1, characterized in that the spherical particles are selected from glass or glass ceramics and have a fire-polished surface.

4. The granulate according to claim 1 characterized in that the individual granules of the granulate are not hollow.

5. The granulate according to claim 1 characterized in that the particles are present in the individual granules in the form of a dense spherical packing.

6. The granulate according to claim 1 characterized in that the granules are present in the form of a dense spherical packing.

7. (canceled)

8. (canceled)

9. The granulate according to claim 1 characterized in that the spherical particles have at least two different diameters.

10. (canceled)

11. The granulate according to claim 1 characterized in that the granulate represents a mixture of substantially smooth spherical particles and unsmooth non-spherical particles.

12. The granulate according to claim 1 characterized in that the minimum weight fraction of the spherical particles in the granulate is selected from the group of values consisting of approximately 0.005, approximately 0.20, and approximately 0.25.

13. The granulate according to claim 1 characterized in that the spherical particles have an average particle size d₅₀ ranging from 0.2 μm to 50 μm.

14. The granulate according to claim 1 characterized in that the mixture includes a ratio of substantially smooth spherical particles to non-spherical particles of between 2:1 and 9:1.

15. The granulate according to claim 1 characterized in that the material of the spherical particles is selected from the group of materials consisting of glass and glass ceramics.

16. The granulate according to claim 1 further comprising an additive selected from the group of additives consisting of defoamers, stabilizers, and pressing additives.

17. The granulate according to claim 1 characterized in that at least a portion of surface of the spherical particles is coated.

18. A process for the production of granulates, the process comprising the steps of:
producing a slip comprising a dispersion medium, substantially smooth spherical particles at least one binder; and
spraying the slip to obtain a granulate, the individual granules of which are not hollow.

19. (canceled)

20. The process according to claim 18, characterized in that the dispersion medium is selected from the group of dispersion mediums consisting of organic carriers, inorganic carriers, organic solvents, water, and mixtures thereof.

21. A suspension-stabilized slip for the manufacture of a granulate, the suspension-stabilized slip comprising a dispersion medium, in particular water, at least one binder, and a quantity of particles including substantially smooth spherical particles.

22. (canceled)

23. (canceled)

24. A process for the manufacture of a compact from a granulate containing at least one binder and substantially smooth spherical particles, the process comprising the steps of:
milling the spherical particles to an average particle size d₅₀ ranging from 0.2 μm to 100 μm;
fire-polishing the spherical particles to smooth the surface;
producing a granulate from the particles obtained, binder, if necessary with the addition of non-spherical particles with a non-smoothed surface and if necessary further additives;
pressing the granulate to obtain a green compact; and
sintering the green compact to obtain a compact.

25. A compact manufactured using a granulate according to claim 1 as well as further additives.

26. A green compact manufactured using a granulate according to claim 1.

27. A glass/metal compound, a glass/glass compact, a glass/glass ceramic compound, or a vitreous solder manufactured using a compact according to claim 25.

28. (canceled)

29. (canceled)

30. A compound manufactured using glass/metal, a glass/glass, or a glass/glass ceramic compound manufactured using a compact according to claim 25.

31. (canceled)

32. The process of claim 18 wherein the slip further comprises at least one of unsmooth, non-spherical particles, and an additive selected from the group of additives consisting of defoamers, stabilizers, and pressing additives.

33. The suspension-stabilized slip of claim 21 further comprising at least one of unsmooth, non-spherical particles, and an additive selected from the group of additives consisting of defoamers, stabilizers, and pressing additives.
